(19) United States
(12) Patent Application Publication
(10) Pub. No.: US 2003/0188203 A1
(43) Pub. Date: Oct. 2, 2003

(54) Networking computer and power controlling method for IDE disk therefor

(75) Inventor: Myoung-Sig Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-city (KR)

(21) Appl. No.: 10/192,553

(22) Filed: Jul. 11, 2002

(30) Foreign Application Priority Data
Mar. 27, 2002 (KR) 2002-16770

(51) Int. Cl. G06F 1/26

(52) U.S. Cl. 713/300

(57) ABSTRACT

A networking computer having a RAID system with a hot-swap function for an IDE disk. A bridge board having a disk connector to which the IDE disk is connected connects the IDE disk to a backplane board of the computer through a CompactPCI connector. The CompactPCI connector is adapted with pins of stepped lengths. A disk power controller determines presence and absence of the IDE disk by sensing whether the pins of the CompactPCI connector come in contact with a CompactPCI connector receiver of the back plane board and controls electric power to the IDE disk according to the determination.

### CROSS REFERENCE TO RELATED APPLICATIONS

This application claims the benefit of Korean Application No. 2002-16770 filed Mar. 27, 2002, in the Korean Patent Office, the disclosure of which is incorporated herein by reference.

### BACKGROUND OF THE INVENTION

1. Field of the Invention

The present invention relates to a networking computer, and more particularly to a networking computer and a method of controlling power for an IDE (integrated drive electronics) disk for the networking computer, in which a hot-swap function is applied to a RAID (redundant array of independent disks) system for the IDE disks through a CompactPCI.

2. Description of the Related Art

As one type of a networking computer, a server computer generally needs a large memory for storing a large amount of data, and a high processing speed for processing the data promptly, and therefore employs a RAID system having a plurality of disks which are connected in parallel and used as one memory. To connect the plurality of disks in parallel, as shown in FIGS. 6 and 7, a backplane board 45 of the server computer comprises a plurality of disk connector receivers 41, a power controller 47 which controls power supplied to each IDE disk 50 by using an EPLD (enhanced programmable logic device), and a data input port (not shown) through which each IDE disk 50 is accessed. Each IDE disk 50 is connected to a respective one of the disk connector receivers 41 of the backplane board 45 through a bridge board 43 formed with a 50-pin IDE connector 55 in which a power port and a data input/output port are incorporated. A connector 51 of the IDE disk 50 is connected to a connector receiver 53 of the bridge board 43.

Recently, a CompactPCI having a hot-swap function is being used as an interface connecting peripheral units with a main board. The hot-swap function allows the peripheral units to be swapped in the state that the server computer is turned on.

Because the server computer processes a large amount of data, the disks are driven hard and are subject to being damaged. If a disk is damaged, the damaged disk should be rapidly swapped with an undamaged disk, but because the hot-swap function is not applied to the conventional backplane board for connecting the IDE disks, the disks should be swapped after turning off the server computer.

### SUMMARY OF THE INVENTION

Accordingly, the present invention has been made keeping in mind the above-described shortcomings and user's need, and an object of the present invention is to provide a networking computer and a method of controlling power for an IDE disk for the networking computer, in which a hot-swap function is applied to a RAID system for the IDE disks through a CompactPCI.

Additional objects and advantages of the invention will be set forth in part in the description which follows, and, in part, will be obvious from the description, or may be learned by practice of the invention.

The above and other objects of the present invention are accomplished by providing a networking computer comprising at least one IDE disk; a power supply which supplies electric power to the IDE disk; a backplane board provided with a compack PCI connector receiver corresponding to each IDE disk; a bridge board having a disk connector to which the IDE disk is connected and a CompactPCI connector which connects to and disconnects from the backplane board together with the IDE disk; and a disk power controller which determines presence/absence of the IDE disk by sensing that pins of the CompactPCI connector are in contact with the CompactPCI connector receiver of the back plane board, and controls the electric power to be supplied to or cut off from the IDE disk according to the determination. The CompactPCI connector progressively connects to and disconnects from the backplane board such that pins carrying electrical power for the IDE disk are connected last where the CompactPCI connector is being connected to the CompactPCI receiver and the pins carrying electrical power for the IDE disk are disconnected first where the CompactPCI connector is being disconnected from the CompactPCI receiver.

The disk power controller may comprise an EPLD (enhanced programmable logic device) provided in the backplane board in order to control electric power.

The CompactPCI connector may comprise a plurality of pins which differ from each other in length.

The disk power controller may control electric power to be supplied to the IDE disk when contact of a shortest pin of the CompactPCI connector is sensed as the IDE disk is connected to the backplane board.

The disk power controller may control electric power to be cut off from the IDE disk when release of the shortest pin of the CompactPCI connector is sensed as the IDE disk is removed from the backplane board.

According to another aspect of the present invention, the above and other objects may be also achieved by providing a method of controlling power for an IDE disk for a networking computer having at least one IDE disk, the method comprising: providing a connection part in a main body of the computer, to which a CompactPCI connector having a plurality of pins which differ in length is connected; providing a sub-connection part connecting the IDE disk with the connection part via the CompactPCI connector; sensing contact of the pins of the CompactPCI connecter as the sub-connection part is connected to the connection part; controlling electric power to be supplied to or cut off from the IDE disk by determining presence/absence of the IDE disk according to the contact of the pins of the CompactPCI connector having the different lengths.

In the controlling of the electric power to be supplied to or cut off from the IDE disk, the electric power may be supplied to the IDE disk where presence of the IDE disk is determined in accordance with contact of the shortest pins of the CompactPCI connector.

The power controlling method may further comprise controlling the electric power to be cut off from the IDE disk where absence of the IDE disk is determined in accordance with release of the shortest pins of the CompactPCI connector.

### BRIEF DESCRIPTION OF THE DRAWINGS

The present invention will be better understood and its various objects and advantages will be more fully appreciated from the following description taken in conjunction with the accompanying drawings, in which:

FIG. 1 is a block diagram of a networking computer according to the present invention having a RAID system for IDE disks;

FIG. 2 is an internal block diagram of a backplane board for the IDE disks of FIG. 1;

FIG. 3 is an internal block diagram of a bridge board connecting the backplane board with the IDE disk of FIG. 1;

FIG. 4 is a flow chart illustrating a process of connecting the IDE disk of FIG. 1;

FIG. 5 is a flow chart illustrating a process of removing the IDE disk of FIG. 1;

FIG. 6 is a block diagram of the conventional backplane board for the IDE disks of the RAID system; and

FIG. 7 is an internal block diagram of the conventional bridge board.

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

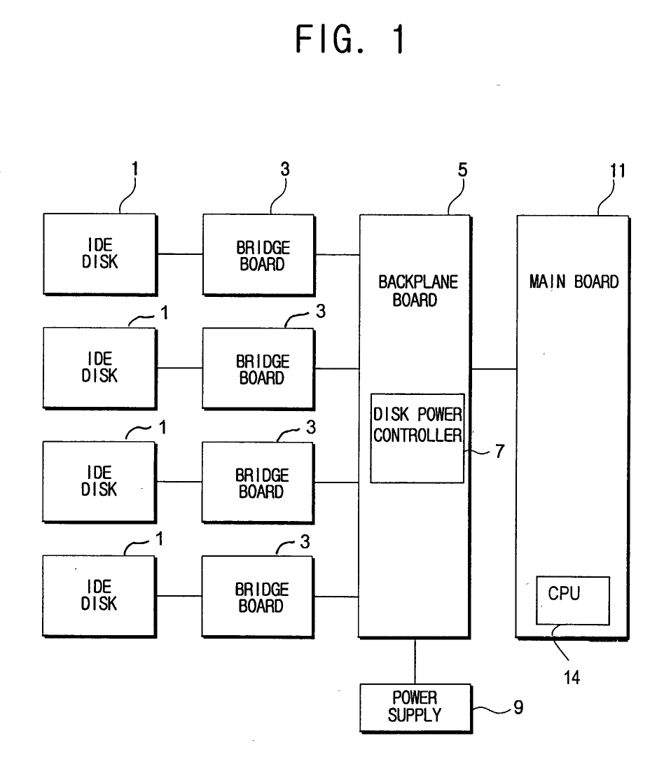

FIG. 1 is a block diagram of a networking computer according to the present invention having a RAID (redundant array of independent disks) system for IDE (integrated drive electronics) disks. As shown in FIG. 1, the networking computer comprises a backplane board 5 to which a plurality of IDE disks 1 are connectable, a plurality of bridge boards 3 through which the plurality of] IDE disks 1 are respectively connected to the backplane board 5, a main board 11 connected to the backplane board 5 with a cable and mounted with a central processing unit 14 which reads/writes data by accessing at least one of the IDE disks 1, and a power supply 9 which supplies electric power to the IDE disks 1 connected to the backplane board 6. In the networking computer, the IDE disks 1 are connected in parallel based on a RAID system, thereby storing a large amount of data and processing the data quickly.

According to the present invention, a CompactPCI specification is employed as an interface for connecting peripheral units with a main board, which has a hot-swap function allowing the peripheral units to be swapped while the networking computer is turned on. Thus, in order to apply the hot-swap function to the plurality of IDE disks 1 connected with each other on the basis of the RAID system, the backplane board 5 and the bridge board 3 have the following configuration.

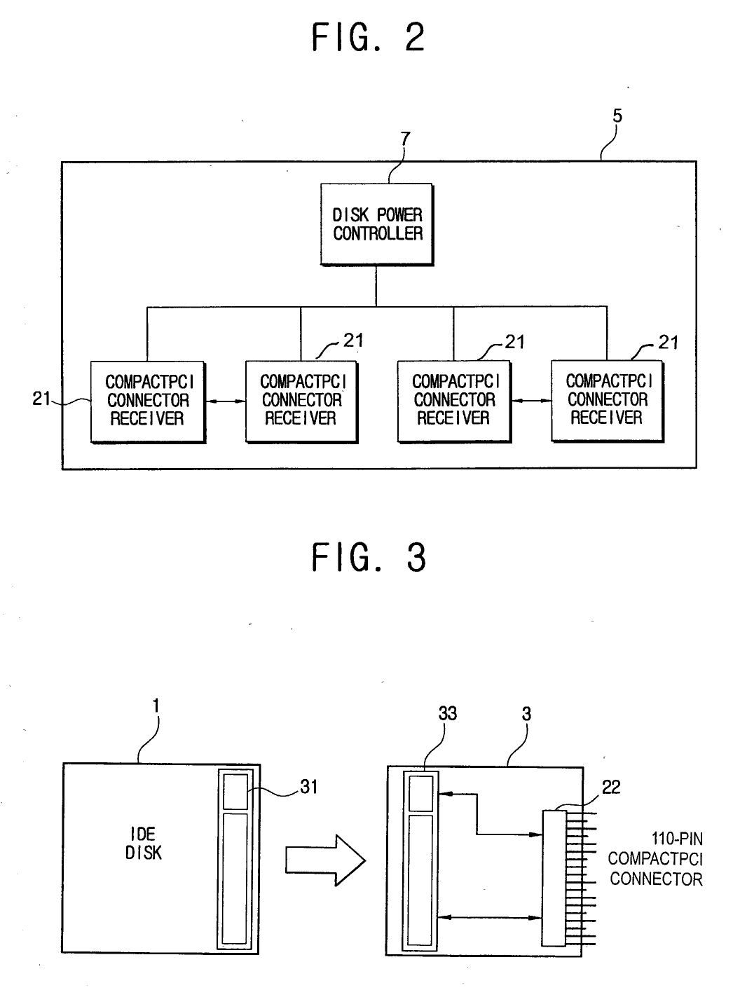

FIG. 2 is an internal block diagram of the backplane board for the IDE disks of FIG. 1. As shown in FIG. 2, the backplane board 5 according to the present invention comprises a plurality of 110-pin CompactPCI connector receivers 21 to which the IDE disks 1 are respectively connectable, a disk power controller 7 which senses whether the IDE disk 1 is connected to the 110-pin CompactPCI connector receiver 21, and controls electric power to be supplied to the IDE disks 1, and an IDE input port (not shown) to which a main board connector (not shown) is connected for accessing the IDE disk 1.

FIG. 3 is an internal block diagram of a bridge board for connecting the backplane board with the IDE disk of FIG. 1. As shown therein, the bridge board 3 comprises an IDE connector receiver 33 to which an IDE disk connector 31 is connected, and a 110-pin CompactPCI connector 22 for connecting the bridge board 3 to the 110-pin CompactPCI connector receiver 21.

The 110-pin CompactPCI connector 22 is formed with a plurality of pins which differ in length (short, normal and long), and an input/output signal of each pin is predetermined to perform a hot-swap function of the CompactPCI specification. Where each pin of the 110-pin CompactPCI connector 22 comes in contact with the 110-pin CompactPCI connector receiver 21, presence/absence of the IDE disk 1 is determined according to a predetermined stepped contact of the pins having the different lengths, thereby performing the hot-swap function of the CompactPCI specification.

That is, where the IDE disk 1 is connected to the backplane board 5, the pins of the 110-pin CompactPCI connector 22 are inserted into the 110-pin CompactPCI connector receiver 21 in order of length, i.e., long length, normal length and short length. Accordingly, as the pins of the 110-pin CompactPCI connector 22 come in contact with the 110-pin CompactPCI connector receiver 21, the disk power controller 7 determines presence/absence of the IDE disk 1.

The disk power controller 7 periodically senses whether the pins of the 110-pin CompactPCI connector 22 are in contact with the 110-pin CompactPCI connector receiver 21, and outputs a disk presence/absence signal to the power supply 9 if predetermined pins of the 110-pin CompactPCI connector 22 are in contact with the 110-pin CompactPCI connector receiver 21. Electric power is supplied to the IDE disk 1 based on the disk presence/absence signal. The disk power controller 7 may comprise an EPLD (enhanced programmable logic device) including power control logic. Preferably, the shortest pins of the 110-pin CompactPCI connector 22, which are last inserted to the 110-pin CompactPCI connector receiver 21, are employed for determining presence/absence of the IDE disk 1 and for supplying electric power to the IDE disk 1. Thus, electric power is supplied to the IDE disk 1 only where the IDE disk 1 is completely connected to the backplane board 5. Further, if the IDE disk 1 is removed, the shortest pins through which the electric power supplied to the IDE disk 1 are disconnected from the 110-pin CompactPCI connector receiver 21. Upon disconnecting the shortest pins, the electrical power is cut off from the IDE disk, thus the longer pins are disconnected after the electric power is cut off.

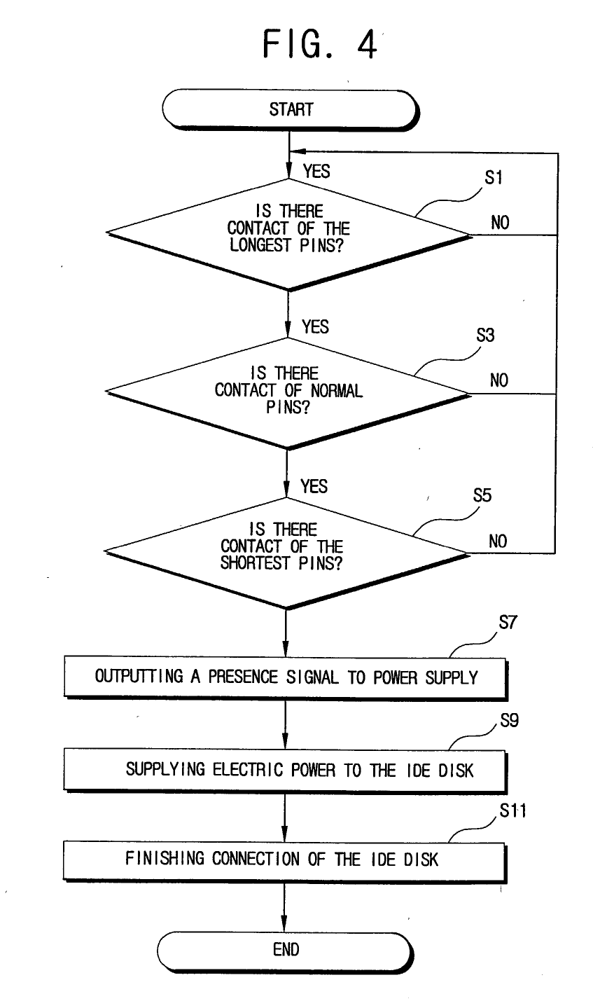

FIG. 4 is a flow chart of a process of connecting the IDE disk 1 with the backplane board 5. As shown in FIG. 4, where the IDE disk 1 is connected to the backplane board 5, the process of pin sensing and power controlling by the disk power controller 7 is as follows. First, when the longest pins of the 110-pin CompactPCI connector 22 come in contact with the 110-pin CompactPCI connector receiver 21 of the backplane board 5 at operation S1, the disk power controller 7 is ready for data communication with the IDE disk 1. Thereafter, normal pins come in contact with the 110-pin CompactPCI connector receiver 21 at operation S3, and then the shortest pins come in contact with the 110-pin CompactPCI connector receiver 21 at operation S5. When the shortest pins come in contact with the 110-pin CompactPCI connector receiver 21, the disk power controller (EPLD) 7 senses the contact of the shortest pins and outputs a disk presence signal “1” to the power supply 9 at operation S7. In response to the disk presence signal, the power supply 9 supplies electric power to the IDE disk 1 at operation S9, thereby finishing the connection of the IDE disk 1 and the backplane board 5 at operation S11.

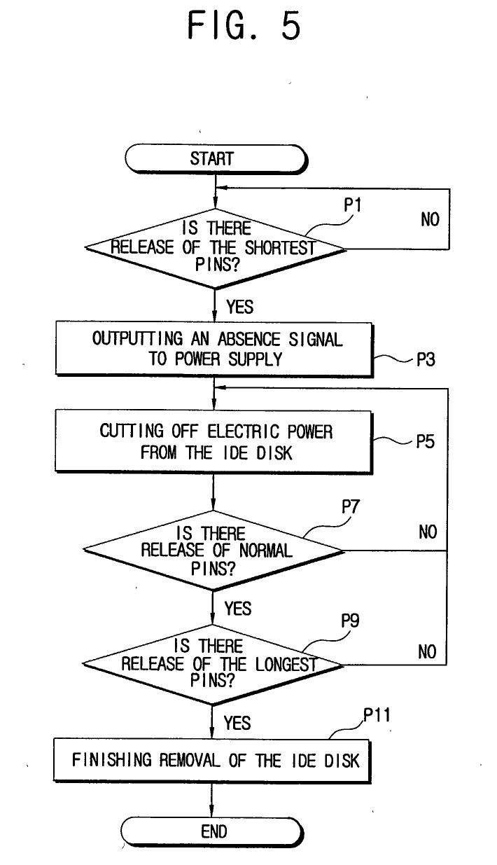

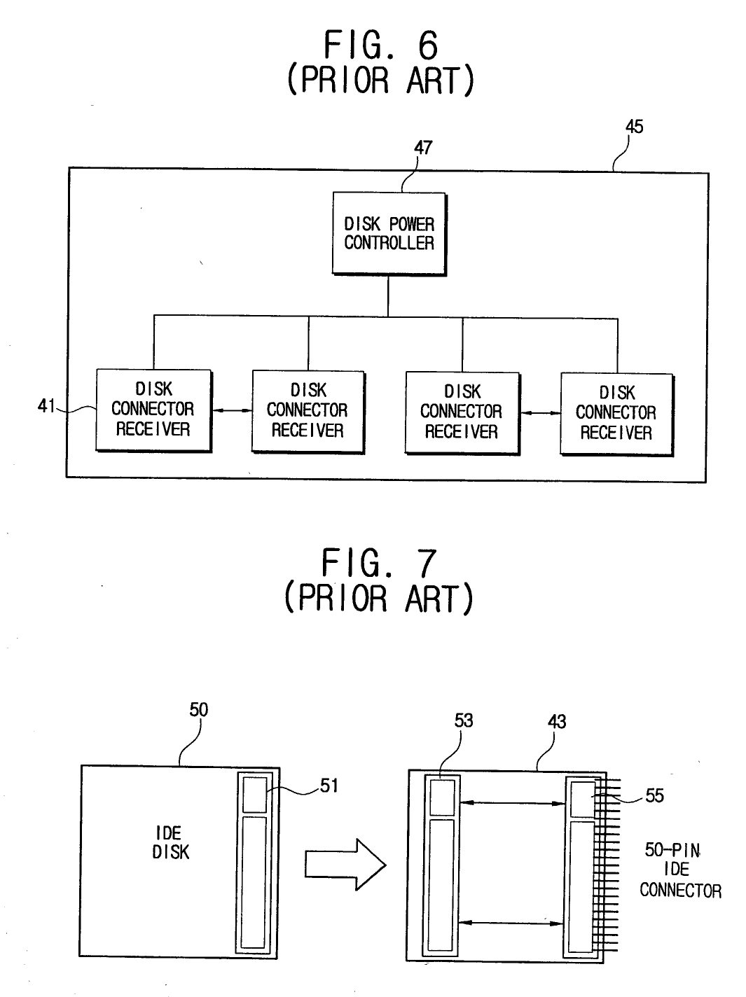

FIG. 5 is a flow chart of a process of removing the IDE disk from the backplane board 5. As shown therein, when the IDE disk 1 is removed from the backplane board 5, the process of pin sensing and power controlling by the disk power controller 7 is as follows. First, when the shortest pins are released from the 110-pin CompactPCI connector receiver 21 at operation P1, the disk power controller 7 senses the release of the shortest pins, and outputs a disk absence signal “0” to the power supply 9 at operation P3. Accordingly, as the disk power controller 7 outputs the disk absence signal “0” to the power supply 9, the power supply 9 cuts off the electric power to the IDE disk 1 at operation P5 (P5). Thereafter, the normal pins are released from the 110-pin CompactPCI connector receiver 21 at operation P7, and then the longest pins are released from the 110-pin CompactPCI connector receiver 21 at operation P9, thereby finishing the removal of the IDE disk 1 from the backplane board 5 at operation P11.

In short, the disk power controller 7 determines presence/absence of the IDE disk 1 by sensing the pins of the 110-pin CompactPCI connector 22 according to pin length, and controls the electric power to the IDE disk 1. Consequently, the IDE disks 1 may be swapped while the server computer is turned on.

With the present invention, one or a plurality of the IDE disks 1 connected to the backplane board through the CompactPCI specification under the RAID system may be swapped without turning off the power to the server computer. Accordingly, the hot-swap function is allowable and the IDE disks 1 may be safely swapped.

As described above, the present invention provides a networking computer and a method of controlling power for an IDE disk for the networking computer, in which a hot-swap function is applied to a RAID system for the IDE disks through a CompactPCI.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A networking computer comprising an IDE disk and a power supply which supplies electric power to the IDE disk, the networking computer further comprising:
a backplane board provided with a CompactPCI connector receiver;
a bridge board having a disk connector to which the IDE disk is connectable and a CompactPCI connector which is connectable to and disconnectable from the CompactPCI connector receiver, the CompactPCI connector having a plurality of pins; and
a disk power controller which:
determines presence/absence of the IDE disk by sensing whether a predetermined one of the plurality of pins is in contact with the CompactPCI connector receiver, and
controls electric power to the IDE disk according to the determination.

2. The networking computer according to claim 1, wherein the disk power controller comprises an EPLD (enhanced programmable logic device) provided in the backplane board which controls the electric power according to the determination.

3. The networking computer according to claim 2, wherein the predetermined one of the plurality of pins differs in length from others of the plurality of pins.

4. The networking computer according to claim 3, wherein the disk power controller applies the electric power to the IDE disk where contact of a shortest of the plurality of pins of the CompactPCI connector with the Compact connector receiver is sensed as the IDE disk is connected to the backplane board.

5. The networking computer according to claim 3, wherein the disk power controller removes electric power from the IDE disk where release of the shortest pin of the CompactPCI connector from the CompactPCI connector receiver is sensed as the IDE disk is removed from the backplane board.

6. A method of controlling power for an IDE disk of a networking computer, comprising:
providing a connection part in a main body of the computer, to which a CompactPCI connector having a plurality of pins different in length is connectable;
providing a sub-connection part connecting the IDE disk with the connection part via the CompactPCI connector;
sensing respective contacts of first and second pins of the plurality pins of the CompactPCI connecter with the connection part; and
controlling electric power to the IDE disk by determining presence/absence of the IDE disk according to the sensing of the contact of the first and second pins.

7. The method of controlling power according to claim 6, wherein the controlling of the electric power comprises supplying the electric power to the IDE disk where the sensing determines respective contacts of the first and second pins.

8. The method of controlling power according to claim 6, wherein the controlling of the electric power comprises removing the electric power from the IDE disk where the sensing determines contact of the first pin and no contact of the second pin.

9. A networking computer comprising:
a disk drive adapted with a CompactPCI connector, the CompactPCI connector having a plurality of pins, wherein at least one of the plurality of pins is of a shorter length than others of the plurality of pins;
a backplane board provided with a CompactPCI connector receiver, the CompactPCI connector receiver adapted to receive the plurality of pins;
a power supply which provides electric power to the disk drive via the at least one of the plurality of pins; and
a central processing unit which writes data to and reads data from the disk drive.

10. The networking computer according to claim 9, further comprising:
a disk power controller which:
determines whether the at least one of the plurality of pins is in contact with the CompactPCI connector receiver; and
controls the electric power to the disk according to the determination.

11. The networking computer according to claim 10, wherein:
during removal of the CompactPCI connector from the backplane board, the disk power controller removes the electric power from the CompactPCI connector receiver prior to separation of the others of the plurality of pins from the CompactPCI connector receiver.

12. The networking computer according to claim 10, wherein the disk power controller comprises an EPLD (enhanced programmable logic device) provided in the backplane board.

13. A networking computer, comprising:
a backplane board provided with a plurality of connector receivers;
a plurality of disk drives, each disk drive adapted with a connector having a plurality of pins, at least one predetermined pin of the plurality of pins having a different pin length than other pins of the plurality of pins, each connector adapted to connect with a respective one of the plurality of connector receivers of the backplane board;
a disk power controller which controls electric power applied to each disk drive according to pin length; and
a central processing unit which writes data to and reads data from the disk drive.

14. A method of hot swapping disk drives in a networking computer having at least a central processing unit and a backplane board provided with a plurality of connector receivers, the method comprising:
providing each disk drive with an adaptor having a connector with a plurality of pins, wherein at least one of the plurality of pins has a shorter length than other pins of the plurality of pins and each connector is adapted to connect with a respective one of the plurality of connector receivers of the backplane board; and
controlling electric power to each disk drive, independently of a control of electrical power to the central processing unit, based on separation and engagement of the one of the plurality of pins with the respective one of the plurality of connector receivers, whereby the disks are swappable without turning off power to the central processing unit.

15. A networking computer, comprising:
a backplane board provided with a plurality of connector receivers;
a plurality of disk drives, each disk drive adapted with a connector having a plurality of pins, predetermined ones of the plurality of pins having short, normal and long lengths, each connector adapted to connect with a respective one of the plurality of connector receivers of the backplane board, each of the plurality of disk drives receiving electrical power through the connector receiver;
a central processing unit which writes data to and reads data from the disk drive; and
a disk power controller which controls electric power applied to each connector receiver, independently of a control of electric power applied to the central processing unit and independently of a control of electric power applied to others of the connector receivers, by sensing a contact of at least one of the short pins with the respective connector receiver.

16. The networking computer according to claim 15, wherein:
upon removal of one of the disk drives from the respective connector receiver, the electric power applied to the connector receiver from which the one of the disk drive is removed is disconnected upon loss of contact of the at least one of the short pins with the respective connector receiver while the respective normal pins and the respective long pins remain connected with the respective connector receiver.

17. The networking computer according to claim 15, wherein:
upon insertion of one of the disk drives into the respective connector receiver, the electric power is connected to the respective connector receiver after the respective long pins and the respective short pins have been inserted into the respective connector receiver and after insertion of the at least one of the short pins into the respective connector receiver.
